(19) United States
(12) Patent Application Publication
(10) Pub. No.: US 2022/0129841 A1
(43) Pub. Date: Apr. 28, 2022

(54) SYSTEM AND METHOD FOR PACKAGE DETECTION AND SECURE DELIVERY

(71) Applicant: Datalogic USA, Inc., Eugene, OR (US)

(72) Inventors: Steven W. Gutke, Eugene, OR (US); Pietro Todescato, Eugene, OR (US)

(21) Appl. No.: 17/081,730

(22) Filed: Oct. 27, 2020

(51) Int. Cl. G06Q 10/08; G07C 9/00

(52) U.S. Cl. CPC G06Q 10/0832; G07C 2009/0092; G07C 9/00896; G06Q 10/0833

(57) ABSTRACT

The disclosure relates to systems and methods for enabling secure delivery and monitoring a delivered package. The systems and methods include a package detection system operable to convey delivery instructions to a delivery person and to communicate with the delivery person. The package detection system is further operable to communicate information about the package delivery to the intended recipient and to facilitate monitoring of the delivered package until the recipient collects the package.

### BACKGROUND

The field of the present disclosure relates generally to systems and methods for detecting and tracking package delivery and for improved security measures to minimize package theft.

With the growing popularity of virtual stores and the improved speed and reliability of e-commerce transactions, online shopping has become a fast growing part of modern society. The ease and convenience of e-commerce transactions has resulted in an increasing amount of package deliveries to homes and businesses. It is common practice for delivery companies to leave packages on a front porch or other typically unsecured designated area when a home or building occupant is unavailable. While a small percentage of packages may require the recipient's signature to complete the delivery, it has become standard practice for package delivery companies to simply leave packages at the destination, often in public view where packages remain for hours until recovered by the recipient. Such delivery practices have unfortunately led to the rapid growth of package theft and result in large financial losses for the businesses.

While some theft may occur as a crime of opportunity, in some instances, more sophisticated thieves may follow a delivery truck to monitor and steal delivered packages that are left unattended at a recipient's home. In other instances, delivery people themselves may steal packages by alleging to have delivered a package when in fact the package was never delivered or intentionally delivered to another home for later recovery. Finally, recipients themselves may take advantage of the increase in package theft and assert that a package was never delivered or stolen in an effort to receive a refund or second package from the vendor.

### BRIEF DESCRIPTION OF THE DRAWINGS

FIG. 1 is a schematic view of a package detection system for monitoring package delivery and tracking package status in accordance with one embodiment.

FIG. 2 is a block diagram illustrating components of the package detection system in accordance with one embodiment.

FIG. 3 is a block diagram of an example method for providing delivery instructions and monitoring a package delivery process in accordance with one embodiment.

FIG. 4 is a block diagram of an example method for tracking a package status after delivery in accordance with one embodiment.

FIG. 5 is a block diagram of an example method for package delivery and tracking in accordance with another embodiment.

### DETAILED DESCRIPTION OF DISCLOSED EMBODIMENTS

With reference to the drawings, this section describes embodiments of systems and methods for detecting package delivery and improving security procedures to ensure package safety and minimize theft. Throughout the specification, reference to “one embodiment,” “an embodiment,” or “some embodiments” means that a described feature, structure, or characteristic may be included in at least one embodiment of the systems and methods described herein. Thus, appearances of the phrases “in one embodiment,” “in an embodiment,” or “in some embodiments” in various places throughout this specification are not necessarily all referring to the same embodiment. Furthermore, the described features, structures, and characteristics may be combined in any suitable manner in one or more embodiments. In view of the disclosure herein, those skilled in the art will recognize that the various embodiments can be practiced without one or more of the specific details or with other methods, components, materials, or the like. In some instances, well-known structures, materials, or operations are not shown or not described in detail to avoid obscuring aspects of the embodiments.

To combat package theft and ensure packages are delivered safely and securely, the present inventors have designed methods and systems for improving package tracking and delivery. One such system is designed to integrate a home security system with a delivery company database to facilitate identification of packages and delivery information and to help track package deliveries. Some systems may include readable optical codes designed to be scanned by the delivery person to obtain additional delivery instructions in the event the residence or business is unoccupied at the time of delivery. Still other systems may be designed to authenticate the delivery company, identify the package, and contact the recipient to ensure the package was delivered to the proper destination. Additional aspects and advantages of these and other systems and methods will be apparent from the following detailed description of example embodiments, which proceed with reference to the accompanying drawings. Understanding that the drawings depict only certain embodiments and are not, therefore, to be considered limiting in nature, these embodiments will be described and explained with additional specificity and detail with reference to the drawings.

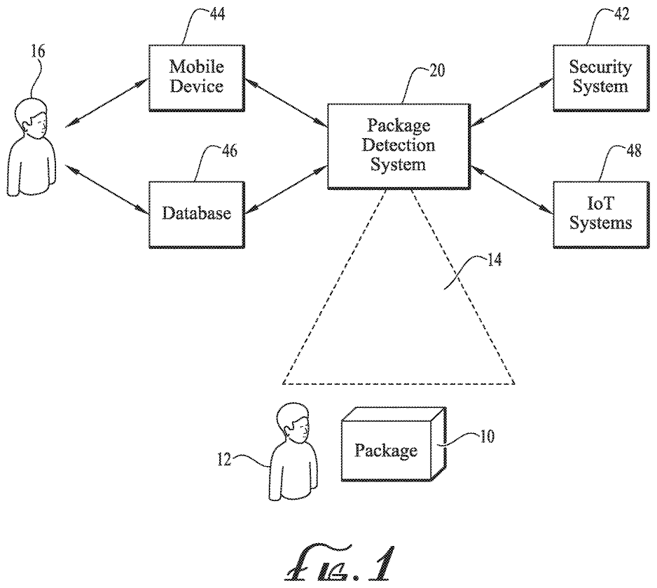

FIGS. 1-5 collectively illustrate various embodiments for systems and methods generally relating to package delivery and tracking. More particularly, the present disclosure relates generally to systems and methods designed for ensuring the secure delivery of a package 10 and for allowing package recipients to verify that delivery has occurred at a specifically designated area. As discussed previously, current delivery practices of leaving packages on front porches, doors, or other unsecured areas provide thieves with opportunities to steal packages at great loss not only to retailers and vendors, but also to recipients expecting personal or sentimental packages that cannot be replaced. As further described in detail below, in some embodiments a package detection system 20 is operable to detect delivery of a package 10 and confirm delivery information (e.g., timestamp of delivery, identity of delivery person, package dimensions, etc.). The package detection system 20 includes customizable features that allow package recipients to provide further instructions to the delivery person upon delivery of the package 10 in the event the person is unavailable to receive the package 10 directly. For example, the package detection system 20 may be used to inform the delivery person of a preferred location to leave the package 10 based on a time of delivery or may grant the delivery person temporary access into a portion of the building or home.

In other embodiments, the package detection system 20 may communicate with other IoT technologies (such as sensors, cameras, security systems, computers, and mobile phones) to observe the package delivery process and to continuously monitor the package 10 after delivery until the package 10 is recovered by an authorized recipient to help combat potential package theft. For example, the various IoT technologies may allow for the recipient to communicate directly with the delivery person to provide additional delivery instructions, may allow the recipient to record or visually monitor the package 10, may sense when the package 10 has been moved outside a camera's field-of-view, and/or may alert the recipient if the package 10 is moved or potential theft activity is detected in the area. Additional details of these and other embodiments of the package delivery and tracking systems 100 are described below with reference to the figures.

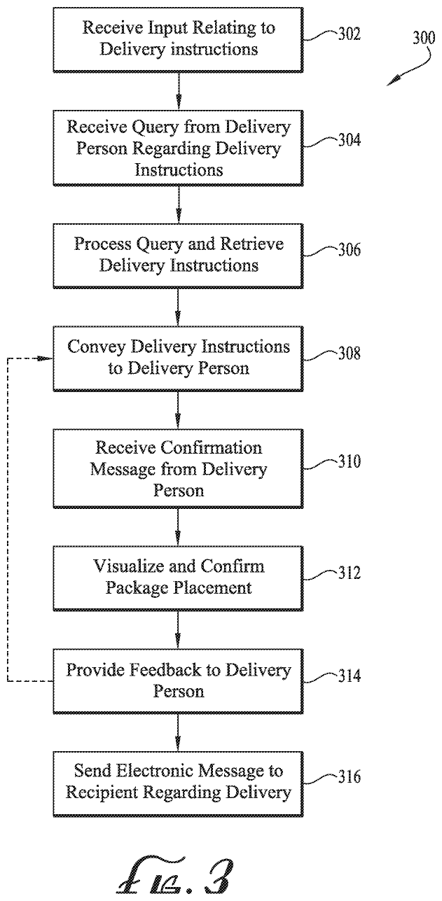

FIG. 1 is a schematic illustration of a package detection system 20 operable for tracking delivery of a package 10 in accordance with one embodiment. With reference to FIG. 1, the package detection system 20 is operable to detect a presence of a package 10 and a delivery person 12 within a field-of-view 14 of the package detection system 20. In some embodiments, the package detection system 20 may be a doorbell camera, an overhead security camera, a standalone camera, or other suitable device preferably with video capabilities for monitoring the field-of-view. Multiple cameras (e.g., doorbell camera, overhead cameras, etc.) may be used and integrated into the package delivery system 20 such that multiple viewing angles may be provided for a more complete view of the delivery area. As further described in detail below, the package detection system 20 may be in communication with various other systems to track and security the package 10. For example, the package detection system 20 may communicate with a security system 42, a mobile phone or other electronic device 44, an external database 46, and other IoT devices 48. Additional details relating to an interaction of the package detection system 20 with these and other systems is provided in detail below with reference to FIGS. 3-5 below.

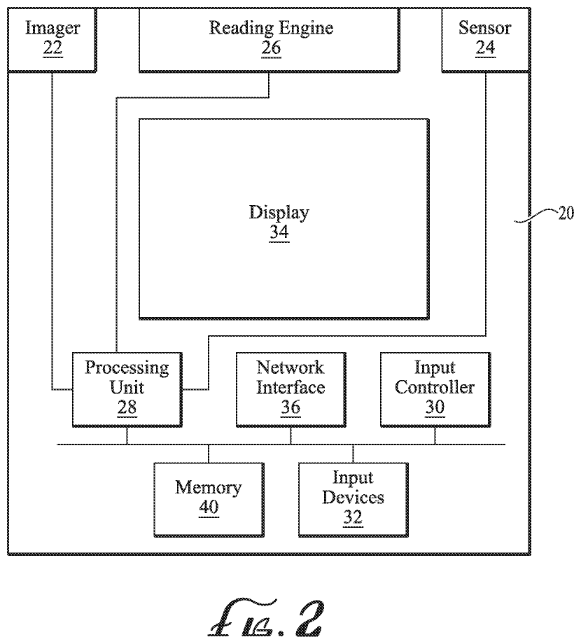

With reference to FIG. 2, in some embodiments, the package detection system 20 may include one or more imaging cameras or imagers 22 housed therein and operable to detect the presence of the package 10 for tracking purposes. In some embodiments, the imagers 22 may be operable to provide a live feed of the field-of-view 14 that is viewable via the recipient's mobile phone 44 or other suitable devices to monitor the package delivery process. In other embodiments, the imagers 22 may record video of the field-of-view and/or may periodically obtain still images of the package 10 and the delivery person 12 when positioned within its field-of-view.

In some embodiments, the package detection system 20 may include a sensor system 24 operable to detect movement within the field-of-view of the imagers 22. In these embodiments, when the sensor system 24 detects movement within the field-of-view 14, such as when the delivery person 12 arrives to deliver the package 10, the sensor system 24 may transmit an activation signal to the imagers 22 to begin recording the scene and/or obtaining images of the field-of-view 14 for tracking and monitoring the package 10.

The package detection system 20 may further include a data reading engine 26 in communication with the imagers 22. The data reading engine 26 may be capable of reading and decoding optical codes, RFID tags, or other data types to identify the package 10. The data reading engine 26 may be any suitable engine capable of reading barcode symbols from the package 20 or from another display device, such as a mobile device carried by the delivery person 12, and may encompass laser scanners, imaging scanners (such as CMOS or CCD-based imagers), cameras, and/or image sensors.

The package detection system 20 may include a processing unit 28, which may be any of various suitable commercially available processors or other logic machine capable of executing instructions. In other embodiments, suitable dual microprocessors or other multi-processor architectures may also be employed as the processing unit 28. The processing unit 28 is in communication with the imagers 22 and/or the data reading engine 26 and capable of performing image-processing techniques to analyze the captured video and/or images. The processing unit 28 may run any suitable image-processing protocols or search for specific logos, words, barcodes, or other suitable item identifiers to identify the package 10. In some embodiments, the processing unit 28 may incorporate the data reading engine 26.

In some embodiments, the package detection system 20 may include an input controller 30 to receive user input from an input device 32, such as a keyboard/keypad, a stylus, microphone, or other suitable device to allow the delivery person 12 to communicate with the recipient as further discussed below. The package detection system 20 may also include a display screen 34 capable of presenting data, prompts, or other communications to the delivery person 12. In some embodiments, the display screen 34 may be a touch screen display capable of receiving input from the delivery person 12 to communicate with the recipient when desired.

The package detection system 20 further includes a network interface 36 to communication with one or more other systems or devices, such as a server, a host computer, a mobile phone, a database, or any suitable IoT devices. The network interface 36 may facilitate wired or wireless communication with other devices over a short distance (e.g., Bluetooth™ or other WiFi standards) or nearly unlimited distances (e.g., the Internet). The package detection system 20 includes a memory unit 40, which may be implemented using one or more standard memory devices. For example, the memory device may include magnetic or optical storage devices, flash memory, removable memory or other suitable memory technologies.

It should be understood that while the illustrated embodiment depicts one possible configuration of a package detection system 20, it should be recognized that a wide variety of hardware and software configurations may be provided. For example, other versions of the package detection system 20 may have fewer than the described components or may contain other components. In addition, it should be understood that some components may be combined or contained in separate systems that communicate with one another. For example, in some embodiments, the processor unit 28 and memory 40 may be contained in a backend system that is in communication with the package detection system 20. It should be understood that all of these configurations are embodied within the scope the disclosed subject matter as further described below.

FIGS. 3-5 collectively illustrate various example embodiments and uses of the package detection system 20 for tracking and monitoring package delivery. The following sections will provide further details of each of these example embodiments with reference to the figures.

FIG. 3 illustrates an example delivery method 300 relating to using the package detection system 20 for tracking and monitoring package delivery in accordance with one embodiment. Briefly, the method 300 describes steps for allowing the recipient to customize package delivery instructions and to confirm that the package 10 is being delivered by the proper delivery company and to the correct destination in accordance with the recipient's instructions. In some embodiments, the method 300 further allows the package detection system 20 to monitor the package 10 and report various details to the recipient and to the delivery company regarding the post-delivery status of the package 10.

With reference to FIG. 3, at step 302, the package detection system 20 receives input from the recipient relating to delivery instructions for handling an expected package delivery. The delivery instructions are designed to provide additional information for the delivery person 12 if the recipient is not home or is otherwise occupied and cannot appear at the door to receive the package 10 at the time of attempted delivery. The package detection system 20 may be programmed with standing delivery instructions as desired to help direct package delivery. In some embodiments, the recipient may elect to set standard options as default for specific delivery companies or for specific items. In other embodiments, delivery instructions may be defined during the checkout process when items are purchased and thereafter communicated to the package detection system 20 via the online merchant's website.

In some embodiments, the recipient may provide simple instructions for all packages 10 to inform the delivery person 12 of a preferred location to place the package 10, such as behind a pillar, a flowerpot, or a side area of the house to better obscure the package 10 from public view. In other embodiments, the instructions may involve delivering the package 10 to an identified neighbor or other person. In still other embodiments, the delivery instructions may be conditioned on the value or contents of individual deliveries. For example, a high-value package may have special delivery instructions that require redelivery when the recipient is home or authorize delivery to a specified neighbor, whereas a lower-value package may provide instructions for delivery behind an adjacent pillar. Similarly, perishable items may have instructions to deliver to a neighbor or may allow the package detection system 20 to authorize temporary access to the home for delivery of the package 10 inside the house or into a refrigerator.

In some embodiments, delivery instructions may change depending on the number of expected deliveries in a day. The package detection system 20 may be configured to interface with the network systems (e.g., via APIs) of one or more different delivery companies to receive delivery status updates to determine how many packages are expected to be delivered on a given day. The resulting delivery instructions may be different than the original instructions provided at checkout or default instructions that may be provided for a single package or packages from a single delivery company. When the package delivery system 20 determines that multiple different delivery companies are expected to deliver packages on the same day, the package delivery system 20 may automatically send new delivery instructions to each delivery company or in some cases may first send a request (e.g., a message or notification with a list of expected deliveries from the different companies) to the recipient to ask if new instructions are desired. The recipient may provide new manual instructions via a response to the message, which may be applied collectively or individually (if different instructions apply) for the different delivery companies. The new instructions may then be updated within the package delivery system 20 (or in some cases transmitted to backed systems to be synched with the deliverer's mobile electronic device) so that the current instructions are available at the time of delivery.

For example, delivery of a single package 10 on a given day may be associated with a simple delivery instruction to leave the package 10 behind a flowerpot, but if the package delivery system 20 identifies that three packages being delivered at the same time or on the same day by multiple delivery companies the package delivery system 20 may trigger a different instruction to deliver all packages 10 (whether they arrive at the same time or separately) to a neighbor to minimize the number of packages sitting on the porch.

In some embodiments, the package detection system 20 monitors the package status (e.g., via its local imager 22 or reading engine 26) and may update delivery instructions as necessary. For example, the delivery options may change depending on whether previous packages from earlier deliveries have already been collected by the recipient as determined by monitoring the packages 10 within its field of view or other detection methods. In such an embodiment, the package detections system 20 may determine that all packages 10 from an earlier delivery from a first delivery company were retrieved by the recipient prior to delivery of the packages from the second delivery company. As a result, the package delivery system 20 may revert back to the default or original delivery instructions for the second delivery if so desired by the recipient. Thus, the delivery instructions may be updated automatically and/or manually responsive to expected deliveries from multiple companies as well as throughout the day as deliveries are made and received.

Once the delivery instructions have been input, the package delivery system 20 is ready for interaction with the delivery person 12. If the recipient is unavailable to receive the package directly 10, at step 304, the package detection system 20 receives a query from the delivery person 12 to determine whether alternate delivery instructions for the package 10 are available. In some embodiments, the delivery person 12 may interact with the package detection system 20 by using any suitable input device 32 or the touch screen display 34. In other embodiments, the delivery person 12 may present a barcode or other readable data to the package detection system 20 for reading, such as via the reading engine 26. The barcode may be an identification tag to identify the delivery person 12 (or the delivery company) to authorize the delivery person 12 to retrieve alternate delivery information from the package detection system 20. In other embodiments, other authorization information may be used, such as a login/password combination or other suitable protocols.

In some embodiments, the query step may include the delivery person 12 entering additional package information, such as value, sender information, or other data that may be used to identify the package 10. In some embodiments, package barcode data may be used to identify the package 10 and obtained directly via the reading engine 26. In such embodiments, the package detection system 20 may use this item information to determine whether special delivery instructions for the package 10 are available based on package value and/or identity. In some embodiments, the delivery instructions may be based on the dimensions of the package 10. The dimensions may be determined from reading the barcode data and retrieving any dimension data that may be on record from identifying the package 10. In some embodiments, the dimensions of the package 10 may be determined by the imagers of the package detection system 20 locating and measuring the package 10 within its field of view and using such dimension data to determine if the size of the package 10 meets a certain threshold for providing different instructions than the original or default instructions.

Upon receiving the query from the delivery person 12, at step 306, the package detection system 20 processes the query and retrieves the applicable delivery instruction. As noted previously, in some embodiments, the delivery instructions may be based on the package value, identity, or other suitable conditions or information received at step 304. Once the appropriate instructions have been retrieved, at step 308, the package detection system 20 conveys the delivery instructions to the delivery person 12. In some embodiments, the package detection system 20 may display the instructions on the screen 34, or may deliver an audible message through a speaker, or may send an electronic message to the delivery person's electronic device, or may employ other suitable communication methods. In other embodiments, the package detection system 20 may convey the delivery instructions and simultaneously unlock a secure box (or provide the delivery person 12 with an access code to manually unlock the box) to receive the delivery. The secure box may be equipped with internal UV lighting to perform anti-microbial treatment of the package 10 before the package 10 is recovered by the recipient and brought inside the home.

In some embodiments, the delivery instructions may include providing temporary access to an otherwise restricted zone to permit package delivery, such as to an interior portion of the recipient's home. For example, upon presenting proper credentials, the package detection system 20 (or the security system 42 in communication with the package detection system 20) may unlock an electronic door lock for the front door or other suitable point of entry, or may provide access to a lock box to allow the delivery person 12 to enter the home. In some embodiments, when such embodiments are employed, the package detection system 20 requires proper authentication (e.g., company ID, facial recognition matching, visual confirmation by recipient via camera, etc.) to provide access to the home, garage, or other point of entry. In these embodiments, the package detection system 20 (or security system 42) may record the scene to determine the amount of time the door has been opened and how long the delivery person 12 was inside. If suitable protocols or conditions are not observed, the package detection system 20 may trigger an alarm and/or contact the recipient or the authorities. For example, if the delivery person 12 enters the house completely rather than simply leaving the package 12 in the entryway, or if the door is opened for too long, the package detection system 20 may alert the recipient, the delivery person 12, the delivery company, and/or the authorities.

Once the delivery instructions have been received and any applicable access points are unlocked, the delivery person 12 then attempts to complete the delivery in accordance with the received instructions. At step 310, once the package 10 has been delivered in accordance with the delivery instructions, the package detection system 20 may receive a confirmation message from the delivery person 12. For example, the delivery person 12 may send an electronic message through an electronic device or may use any suitable input device 32 of the package detection system 20.

At step 312, the package detection system 20 may use the imagers 22 (or may communicate with and receive information from other cameras/security systems with a view of the package 10) to visualize and confirm placement of the package 10 in accordance with the appropriate delivery instructions. For example, the imagers 22 may confirm that the package 10 is sitting behind the pillar on the front porch of the recipient's house as instructed. The determination may be made based on the dimensions of the package 10 and/or by reading any visible barcode or other suitable indicia on the package 10 via the imagers 22 and reading engine 26. In some embodiments, the dimensions of the package 10 may be obtained by the package detection system 20 at step 304 when the delivery person 12 queries the system 20 for delivery instructions. For example, as part of the query process, the delivery person 12 may scan the barcode of the package 10 or may present the package 10 for scanning/imaging to allow the package detection system 20 to obtain the necessary information.

At step 314, the package detection system 20 may provide feedback to the delivery person 12 regarding package delivery. If the package 10 has been delivered in accordance with the delivery instructions, the package detection system 20 may send a confirmation message to the delivery person 12 or emit a successful sound to confirm the delivery. Similarly, the package detection system 20 may notify the delivery person 12 that the package 10 has not been placed properly and request that the package 10 be moved to the proper location. At step 316, once the package 10 has been properly delivered, the package detection system 20 may send an electronic message to the recipient regarding package delivery and placement, and providing package delivery details, such as a time stamp and identity of the delivery company and delivery person 12. In some embodiments, the package detection system 20 may provide images or video of the delivery process and the package location, or may provide a live feed to facilitate regular monitor of the package 10 throughout the day.

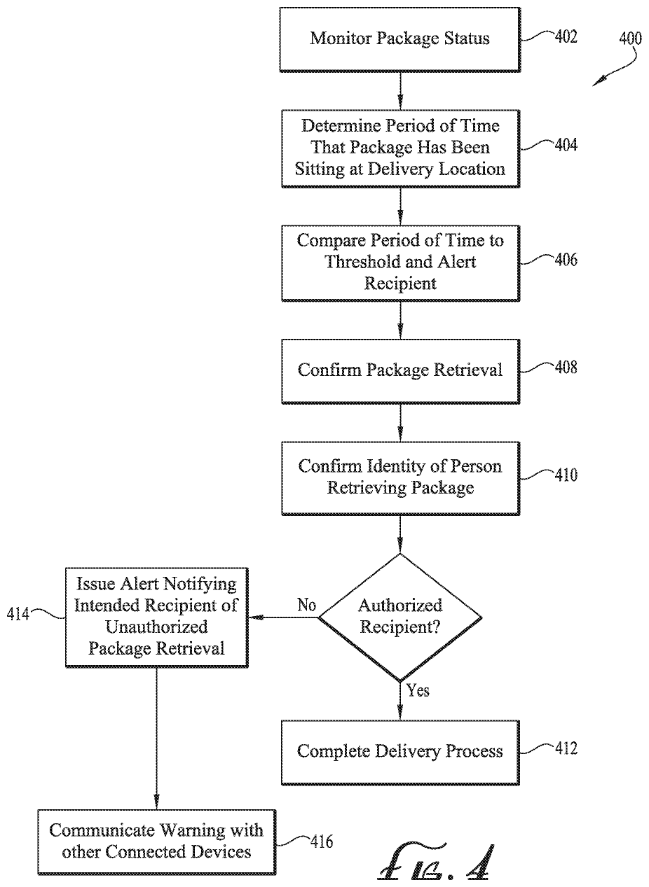

FIG. 4 illustrates an example monitoring method 400 using the package detection system 20 for monitoring the package 10 after delivery to help ensure its security in accordance with one embodiment. With reference to FIG. 4, at step 402, the package detection system 20 monitors the status of the package 10, such as via the imagers 22, until the package 10 is collected. As discussed above, the package detection system 20 may include one or more imagers such as a doorbell camera, overhead security cameras, etc. The package 10 may be within the field of view of all cameras or in some cases only a subset depending on the location of the package 10 and the field of views of the different cameras. The package detection system 20 may continuously or periodically record the scene using the different imagers to track real-time information relating to the package 10 and its status. At step 404, the package detection system 20 determines a period of time that the package 10 has been sitting within the field-of-view 14 and compares that determined period of time with programmed conditions. At step 406, if the package 10 has been sitting for longer than the set amount of time in the programmed conditions, the package detection system 20 sends a communication to the recipient with a reminder that the package 10 has been delivered and is awaiting retrieval. In some embodiments, the communication to the recipient may include a photo of the delivery and/or package identification information (such as address of sender, time of delivery, delivery company, package contents, etc.).

At step 408, once the recipient has collected the package 10, the package detection system 20 confirms that the package 10 has been retrieved. In some embodiments, the recipient may use any suitable input device 32 to communicate to the package detection system 20 that the package 10 has been retrieved. In other embodiments, the package detection system 20 may automatically determine that the package 10 has been collected if the package 10 is no longer detected within its field of view 14. For example, in some embodiments, the imager 22 may record when the package 10 is removed from its delivery position and note the direction of movement of the person collecting the package 10. Based on the direction of movement, the package detection system 20 may determine whether the package 10 has been successfully retrieved or may trigger an alarm or issue another alert to raise suspicion of potential theft. For example, if the package 10 is retrieved and the person is detected as moving into the house or toward the direction of the house, then no alarm is triggered, and the delivery is confirmed. If the person retrieving the package 10 instead moves away from the house, the package detection system 20 may determine that a theft is in process and trigger the alarm and/or send an alert to the recipient.

In some embodiments, the package detection system 20 at step 410 determines an identity of the person collecting the package 10. For example, the package detection system 20 may include facial recognition software for authorized users, such as family members, friends, and neighbors. When the package 20 is retrieved, the package detection system 20 may obtain an image of the person collecting the package 10 and analyze that image to verify that the person is an authorized user. At step 412, if the person is an authorized user, the package detection system 20 takes no further action and the delivery process is completed. If the person is not an authorized user, at step 414, the package detection system 20 may issue an alarm or alert notifying the intended recipient that the package 10 has been recovered by an unauthorized user. The package detection system 20 may include a photo or video of the unauthorized user for aiding in identifying the person. In some embodiments, the package detection system 20 may also notify the delivery person 12 that the package 10 has been taken by an unauthorized person to alert the delivery person 12 about potential theft in the area. Upon receiving the alert, the delivery person 12 may elect to change delivery tactics for any remaining deliveries in the area, such as by delivering only directly to people or only to secure, locked areas or mailboxes, to minimize the risk of further theft.

In some embodiments, at step 414, the package detection system 20 may communicate with other suitable package detection systems or electronic devices in the neighborhood or surrounding area to alert others waiting on package deliveries about potential theft. Upon receiving this message, those recipients may opt to change their delivery instructions if they are expecting to receive a package that day. In some embodiments, multiple alerts relating to a single delivery route may trigger messages that the delivery person 12 may be untrustworthy. Upon receiving these alerts from other connected systems, the package detection system 20 may alter its default instructions and restrict access to a home, require additional approval from the recipient, or take other suitable precautions to strengthen access criteria as needed. In other embodiments, the package detection system 20 may be in communication with the delivery company to notify them of potential theft relating to the route of the delivery person 12 so that the delivery company can monitor and potentially uncover theft perpetrated by the delivery person 12.

Embodiments of the disclosure include delivery situations of single family homes as well as multi-unit residential communities such as condominiums, duplexes, apartment buildings, etc. In some situations, conventional systems do not properly identify the door or unit where the package 10 has been or should be delivered. In many cases, GPS coordinates among two sequential doors appear identifical which makes it difficult for the delivery person to ensure that packages have been correctly delivered.

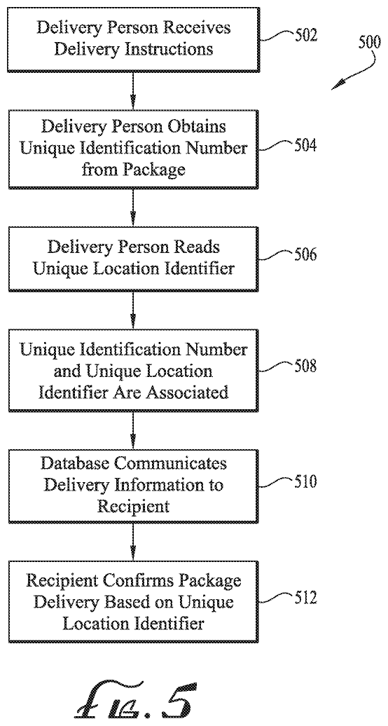

FIG. 5 illustrates a package delivery and tracking method 500 in accordance with another embodiment. With reference to FIG. 5, the tracking method 500 allows a user to identify a specific door or area where a package 10 is to be delivered. As further described in detail below, the method 500 envisions the use of unique location identifiers for a door in the form of barcodes, RFID tags, beacons (e.g., NFC, BLE), or other suitable devices designed to identify a specific door or area where a package should be delivered. Having a unique identifier for a specific door may be particularly advantageous for such multi-unit locations, which in some cases may not have a full set up of imagers or other hardware associated with a package delivery system described above.

In some embodiments, the identifiers may further provide the recipient's contact information to allow the delivery person 12 to send a text message, e-mail, or other communication to notify the recipient that a package 10 has been delivered along with information relating to the time of delivery and the specific door or location where the delivery was made. In some embodiments, the unique location identifier may automatically contact the recipient to provide this information after delivery.

In some embodiments, the unique location identifiers are arranged adjacent or near the doors or regions adjacent the home where deliveries will occur. In one embodiment, the unique location identifiers may be printed barcode labels with an adhesive backing where the barcode labels can be easily adhered adjacent the target delivery areas. Other labels with RFID, NFC or other functionality are also contemplated.

For example, one recipient may have a unique location identifier next to the front door, the back door, the side door, the garage door, and/or another delivery area of the house. In another embodiment, multiple residents of a multi-unit building (e.g., condominium, apartment complex, etc.) may have unique location identifiers proximate their doors or units that are associated to the resident(s) of that unit. In such embodiments, when a new resident (e.g., tenant) moves into the home or residential unit, the unique location identifiers can be easily replaced and be associated with the new resident.

Turning now to FIG. 5, at step 502, the delivery person 12 receives instructions for delivering the package 10. The instructions may be input as part of the item purchasing process, stored on a secured cloud network, sent separately by the recipient directly to the delivery company, or may be obtained from a package detection system 20 such as described with reference to FIGS. 1-4. In some embodiments, the unique location identifier associated with the customer may be provided during the item purchasing process (e.g., as additional information than just the delivery address). The delivery instructions received at step 502 indicate the door or other area at which the package 10 is to be delivered. In some embodiments, the unique location identifier may include a WiFi enabled tag with a light-emitting diode (LED) or other suitable illumination source may respond to a ping from an electronic device carried by the delivery person 12 to allow the delivery person 12 to more easily identify the proper door or delivery area referenced by the delivery instructions for the package 10.

In some embodiments, an NFC chip or other similar chip may be integrated into the mobile device of the delivery person. An accessory is also contemplated, such as one suitable for being clamped to a cable and also equipped with an NFC chip, capacitive pads, keyboard, or any other input device to input the unique identifier code at the door or to receive the configuration information (e.g., stored in the NFC chip and transmitted to the companion receiver in the mobile device).

At step 504, the delivery person 12 reads or scans the unique identification number from the package 10. At step 506, the delivery person 12 scans, reads, or otherwise obtains information from the unique location identifier using any suitable electronic reading device. In some embodiments, the unique location identifier may be encrypted and require authorization before the data may be properly read. For example, after the delivery person 12 scans the unique location identifier, the delivery person 12 may enter login information, biometric data, or other suitable identification information for authentication purposes before decryption keys are provided.

At step 508, the package 10 and the unique location identifier are associated together via a database or other electronic device to reflect that the package 10 has been delivered at the location based on the unique location identifier. At step 510, the database or electronic device communicates information to the recipient about the package delivery, such as via a push notification, text message, email, or other suitable form of communication. The communication may indicate the time of delivery and/or other package information and indicate the location at which the package 10 was delivered based on the information obtained from the unique location identifier. In some embodiments, the recipient's contact information may be embedded in the unique location identifier to allow any authorized delivery service to contact the recipient directly. In such embodiments, an electronic device with encrypted communication protocols may be required to access customer contact information.

At step 512, after receiving the communication relating to package delivery, the recipient may confirm that the package 10 has been delivered at the proper location based on the unique location identifier. In some embodiments, the recipient may activate a camera and review a camera feed to confirm that the package 10 was delivered at the proper door or area in accordance with the unique location identifier.

In some embodiments, the unique location identifier (e.g., label) that is associated with a specific door or location may be used to simplify or provide flexibility without the full cost of a package delivery system. In some embodiments, the mobile devices that are used to read the unique location identifier may not need to be configured to acquire CAPEX information from the delivery companies. In some embodiments, the mobile devices may be configured to confirm that the package is at the correct destination associated with the recipient via the unique location identifier and then the mobile device transmits (e.g., via a cellular network or other network) a message (e.g., text) with the delivery confirmation which may include other information such as delivery time, deliver information, etc. In some embodiments, the mobile device may require the delivery person to take a picture of the package at the proper location to attach to the message confirming delivery.

In some embodiments, features of the methods 300 and 400 may be combined with features of the method 500 without departing from the principles of the disclosure. For example, the unique location identifiers may be used in conjunction with the package detection system 20 to provide additional information to the delivery person 12, or to allow the camera/security systems to monitor package delivery to a door as specified by the unique location identifiers. In some embodiments, the unique location identifier may be used to provide an alternate mode of communication with the delivery person 12 in instances where the package detection system 20 fails or is offline, or if the delivery person 12 cannot interact with the package detection system 20 for any reason.

It should be understood that many of the components and arrangements described in the embodiments of FIGS. 1-5 are for illustration purposes. In other embodiments, certain steps in the methods may be rearranged or omitted without departing from the principles of the disclosed subject matter. In addition, components of the package detection system may be rearranged, combined, or omitted without departing from the principles of the disclosure.

It is intended that subject matter disclosed in portion herein can be combined with the subject matter of one or more of other portions herein as long as such combinations are not mutually exclusive or inoperable. In addition, many variations, enhancements and modifications of the concepts described herein are possible.

The terms and descriptions used above are set forth by way of illustration only and are not meant as limitations. Those skilled in the art will recognize that many variations can be made to the details of the above-described embodiments without departing from the underlying principles of the invention.

1. A method for secure delivery of a package, the method comprising:
storing, via a package detection system, delivery instructions relating to a delivery of a package to a delivery area;
receiving, via the package detection system, a request from a delivery person for the delivery instructions;
retrieving, via the package detection system, the delivery instructions in response to the request from the delivery person;
conveying, via the package detection system, the delivery instructions for the package to the delivery person, the delivery instructions identifying the delivery area for the delivery of the package;
monitoring, via the package detection system, the identified delivery area to confirm a presence of the package within the identified delivery area; and
communicating, via the package detection system, information to a package recipient relating to the presence of the package in the identified delivery area.

2. The method of claim 1, further comprising:
obtaining, via the package detection system, information relating to an identity of the delivery person; and
analyzing, via the package detection system, the information to authenticate the identity of the delivery person prior to the step of conveying the delivery instructions.

3. The method of claim 1, wherein the identified delivery area is in a restricted area secured by a lock, the method further comprising unlocking the lock to grant the delivery person access to the restricted area to facilitate package delivery to the identified delivery area.

4. The method of claim 3, further comprising:
determining an amount of time corresponding to a presence of the delivery person in the restricted area;
comparing the determined amount of time to a threshold value stored in the package detection system; and
generating an alert in response to the amount of time exceeding the threshold value.

5. The method of claim 1, wherein the stored delivery instructions further includes two or more conditional delivery instructions relating to contents of the package, the method further comprising:
determining, via the package detection system, contents of the package,
wherein the step of retrieving the delivery instructions further includes selecting one of the two or more conditional delivery instructions based on the determined contents of the package, and wherein the step of conveying the delivery instructions includes conveying the selected one of the two or more conditional delivery instructions to the delivery person.

6. The method of claim 1, wherein the stored delivery instructions further includes two or more conditional delivery instructions relating to a value of the package, the method further comprising;
determining, via the package detection system, a value of the package,
wherein the step of retrieving the delivery instructions further includes selecting one of the two or more conditional delivery instructions based on the determined value of the package, and wherein the step of conveying the delivery instructions includes conveying the selected one of the two or more conditional delivery instructions to the delivery person.

7. The method of claim 1, further comprising:
capturing, via the package detection system, one or more images of the package and the identified delivery area, and
wherein the step of communicating information to the package recipient further includes communicating the one or more images of the package and the identified delivery area.

8. The method of claim 1, further comprising:
monitoring, via the package detection system, the identified delivery area and the package after delivery;
detecting, via the package detection system, a presence of a person within the identified delivery area;
detecting, via the package detection system, a movement of the package within the identified delivery area by the detected person;
determining, via the package detection system, a direction of motion of the detected person and the package relative to the identified delivery area; and
generating, via the package detection system, an alert based on the direction of motion of the person and the package relative to the identified delivery area.

9. The method of claim 1, further comprising:
monitoring, via the package detection system, the identified delivery area and the package after delivery;
determining, via the package detection system, an elapsed amount of time for a presence of the package within the identified delivery area;
comparing, via the package detection system, the determined elapsed amount of time with a threshold value; and
communicating, via the package detection system, a message to the package recipient about the package when the elapsed amount of time exceeds the threshold value.

10. The method of claim 1, wherein the package detection system is in communication with a remote system and wherein the stored delivery instructions further includes two or more conditional delivery instructions based on a communication from the remote system, the method further comprising;
receiving, via the package delivery system, a communication from the remote system;
analyzing, via the package delivery system, the communication from the remote system;
selecting, via the package detection system, the one of the two or more conditional delivery instructions based on the communication from the remote system, and
and wherein the step of conveying the delivery instructions includes conveying the selected one of the two or more conditional delivery instructions to the delivery person.

11. The method of claim 1, wherein the step of storing delivery instructions includes storing, via the package detection system, a plurality of delivery instructions each one of the plurality of delivery instructions associated with a unique delivery area for delivery of the package, and wherein each unique delivery area is further associated with a unique location identifier, the method further comprising:
conveying, via the package detection system, the delivery instructions for the package to the delivery person, the delivery instructions including a selected one of the unique delivery areas;
obtaining, by the delivery person, location data from the unique location identifier associated with the selected unique delivery area;
obtaining, via the package detection system, identification data relating to the package;
associating, via the package detection system, the location data obtained from the unique location identifier and the identification data obtained from the package;
communicating, via the package detection system, to the package recipient the selected unique delivery area for package delivery based on the associated unique location identifier.

12. A package detection system for secure delivery of a package, comprising:
a memory unit configured for storing delivery instructions relating to a delivery of a package to a delivery area;
an input device configured for receiving a request from a delivery person for the delivery instructions;
a processor in communication with the memory unit and input device, the processor configured for retrieving the delivery instructions in response to the input device receive the request from the delivery person;
an output device in operable communication with the processor, the output device configured for conveying the delivery instructions for the package to the delivery person, the delivery instructions identifying the delivery area for the delivery of the package;
an imaging system configured for monitoring the identified delivery area and detecting a presence of the package within the identified delivery area; and
a communication unit configured for communicating information to a package recipient relating to the presence of the package in the identified delivery area in response to the imager detecting the presence of the package.

13. The package detection system of claim 12, wherein processor is further in operable communication with a lock to a restricted area, the processor further configured for unlocking the lock to grant the delivery person access to the restricted area to facilitate package delivery to the identified delivery area, and wherein the processor is further configured for determining an amount of time corresponding to a presence of the delivery person in the restricted area, and comparing the determined amount of time to a threshold value stored in the package detection system, the communication unit further configured for generating an alert in response to the amount of time exceeding the threshold value.

14. The package detection system of claim 12, wherein the stored delivery instructions further includes two or more conditional delivery instructions relating to contents of the package, and wherein the processor is further configured for determining contents of the package and selecting one of the two or more conditional delivery instructions based on the determined contents of the package, the output device conveying the selected one of the two or more conditional delivery instructions to the delivery person.

15. The package detection system of claim 12, wherein the stored delivery instructions further includes two or more conditional delivery instructions relating to a value of the package, and wherein the processor is further configured for determining the value of the package and selecting one of the two or more conditional delivery instructions based on the determined value of the package, the output device conveying the selected one of the two or more conditional delivery instructions to the delivery person.

16. The package detection system of claim 12, wherein the imaging system is further configured for monitoring the identified delivery area and the package after delivery, detecting a presence of a person within the identified delivery area, and detecting a movement of the package within the identified delivery area by the detected person, and wherein the processor is further configured for determining a direction of motion of the detected person and the package relative to the identified delivery area, the communication unit further configured for generating an alert based on the direction of motion of the person and the package relative to the identified delivery area.

17. The package detection system of claim 12, wherein the imaging system is further configured for monitoring the identified delivery area and the package after delivery, the processor further configured for determining an elapsed amount of time for a presence of the package within the identified delivery area and comparing the determined elapsed amount of time with a threshold value, and wherein the communication unit further configured for generating a message to the package recipient when the elapsed amount of time exceeds the threshold value.

18. The package detection system of claim 12, wherein the package detection system is in communication with a remote system and wherein the stored delivery instructions further includes two or more conditional delivery instructions based on a communication from the remote system, and wherein the package detection is further configured for receiving a communication from the remote system and analyzing the communication from the remote system, the processor further configured for selecting the one of the two or more conditional delivery instructions based on the communication from the remote system, and wherein the output device is further configured for conveying the selected one of the two or more conditional delivery instructions to the delivery person.

19. A method for secure delivery of a package, the method comprising:
storing, via a package detection system, delivery instructions relating to a delivery of a package to one of a plurality of delivery areas;
storing, via the package detection system, one or more unique location identifiers, where each of the one or more unique location identifiers is associated with a corresponding delivery area of the plurality of delivery areas;
receiving, via the package detection system, a unique identification number obtained from the package;
retrieving, via the package detection system, the delivery instructions in response to the received unique identification number;
conveying, via the package detection system, the delivery instructions for the package to the delivery person, the delivery instructions identifying a selected delivery area from the plurality of delivery areas for delivery of the package;
receiving, via the package detection system, information from the unique location identifier associated with the selected delivery area after delivery of the package to the selected delivery area; and
validating, via the package detection system, delivery of the package in accordance with the delivery instructions based on the received information from the unique location identifier associated with the selected delivery area.

20. The method of claim 19, further comprising:
communicating, via the package detection system, information to a package recipient relating to the presence of the package in the selected delivery area; and
monitoring, via the package detection system, the selected delivery area based on the unique location identifier to confirm delivery of the package.
